(19) United States
(12) Patent Application Publication
(10) Pub. No.: US 2020/0055754 A1
(43) Pub. Date: Feb. 20, 2020

(54) WATER TREATMENT APPARATUS, WATER TREATMENT SYSTEM AND WATER TREATMENT METHOD

(71) Applicants: KABUSHIKI KAISHA TOSHIBA, Minato-ku (JP); TOSHIBA INFRASTRUCTURE SYSTEMS & SOLUTIONS CORPORATION, Kawasaki-shi (JP)

(72) Inventors: Seiichi MURAYAMA, Fuchu (JP); Naohiko SHIMURA, Atsugi (JP); Kanako MORITANI, Yokohama (JP); Ryutaro MAKISE, Yokohama (JP); Kie KUBO, Toshima (JP)

(73) Assignees: KABUSHIKI KAISHA TOSHIBA, Minato-ku (JP); TOSHIBA INFRASTRUCTURE SYSTEMS & SOLUTIONS CORPORATION, Kawasaki-shi (JP)

(21) Appl. No.: 16/344,687

(22) PCT Filed: Sep. 19, 2017
(86) PCT No.: PCT/JP2017/033767

§ 371 Date: Apr. 24, 2019

(30) Foreign Application Priority Data
Nov. 4, 2016 (JP) 2016-216637

(51) Int. Cl. C02F 1/78; B01F 3/04; B01F 5/04; C02F 1/461

(52) U.S. Cl. CPC C02F 1/78; B01F 3/04; B01F 5/04; C02F 2001/46133; C02F 2201/46105; C02F 2201/782; C02F 1/46114

(57) ABSTRACT

A water treatment apparatus includes: a reaction vessel that contains water to be treated, including an upper part from which the water to be treated is introduced and a lower part from which the water to be treated is discharged, to form a downward flow; an ozone supply unit that supplies ozonized gas into the reaction vessel from the lower part to form an upward flow of the ozonized gas containing ozone gas and oxygen; and an electrolysis electrode pair disposed on the upper part of the reaction vessel, the pair that produces hydrogen peroxide from the water to be treated and the oxygen gas contained in the ozonized gas by electrolysis.

### FIELD

Embodiments of the present invention relate generally to a water treatment apparatus, a water treatment system, and a water treatment method.

### BACKGROUND

Conventionally, in the fields of clean water, sewage water, industrial drainage, and swimming pool, ozone has been used for treatment of organic substances in water, such as oxidative decomposition, sterilization, and deodorization. Through ozone oxidation, organic substances may be able to become hydrophilic and depolymerized, but cannot be mineralized. Ozone oxidation cannot work to decompose persistent organic substances, such as dioxin and 1,4-dioxane.

Thus, to decompose the above persistent organic substances, one of effective means is to use OH radicals more oxidative than ozone for oxidative decomposition.

For production of OH radicals for water treatment, generally used methods include irradiating ozone-containing water with ultraviolet rays; adding ozone to hydrogen peroxide-containing water, irradiating hydrogen peroxide-containing water with ultraviolet rays; and using hydrogen peroxide, ozone, and ultraviolet rays all together.

### CITATION LIST

### Patent Literature

Patent Literature 1: Japanese Patent Application

Patent Literature 2: Japanese Patent Application Publication No. 2006-82081

Patent Literature 3: Japanese Patent Application Publication No. H10-165971

### SUMMARY OF THE INVENTION

### Problem to be Solved by the Invention

Use of light including ultraviolet rays requires increased amount of irradiation and higher energy for treating water having low ultraviolet transmittance. For this reason, ozone and hydrogen peroxide are often used for production of OH radicals.

However, hydrogen peroxide is a deleterious substance, which requires preparation of storage equipment and injection equipment as well as stringent safety management. Thus, there have been requests for more introducible water treatment apparatuses.

In view of the above problem, an object of the present invention is to provide a water treatment apparatus, a water treatment system, and a water treatment method that can produce highly oxidative OH radicals to oxidize and decompose persistent substances in the water without use of hydrogen peroxide as reagent.

### Means for Solving Problem

A water treatment apparatus according to one embodiment includes a reaction vessel that can contain water to be treated, and that includes an upper part from which the water to be treated is introduced and a lower part from which the water to be treated is discharged, to be able to form a downward flow; an ozone supply unit that supplies ozonized gas into the reaction vessel from the lower part to be able to form an upward flow of the ozonized gas containing ozone gas and oxygen; and an electrolysis electrode pair placed on the upper part of the reaction vessel, the pair that produces hydrogen peroxide from the water to be treated and the oxygen gas contained in the ozonized gas by electrolysis.

### BRIEF DESCRIPTION OF DRAWINGS

FIG. 1 is a schematic configuration block diagram of a water treatment system according to a first embodiment;

FIG. 2 is an explanatory diagram of distributions of ozone concentration, hydrogen peroxide concentration, and OH radical concentration in the case of Pattern A;

FIG. 3 is an explanatory diagram of distributions of ozone concentration, hydrogen peroxide concentration, and OH radical concentration in the case of Pattern B;

FIG. 4 is an explanatory diagram of distributions of ozone concentration, hydrogen peroxide concentration, and OH radical concentration in the case of Pattern C;

FIG. 5 is an explanatory diagram of distributions of ozone concentration, hydrogen peroxide concentration, and OH radical concentration in the case of Pattern D;

FIG. 6 is a schematic diagram of hydrogen peroxide production with an electrolysis electrode pair;

FIG. 7 is an explanatory diagram of an operation of generating OH radicals;

FIG. 8 is an explanatory diagram of a first modification of the first embodiment; and

FIG. 9 is a schematic configuration block diagram of a water treatment apparatus according to a second embodiment.

FIG. 10 is an explanatory diagram of a third embodiment.

### DETAILED DESCRIPTION

The following will describe embodiments with reference to the accompanying drawings.

### [1] First Embodiment

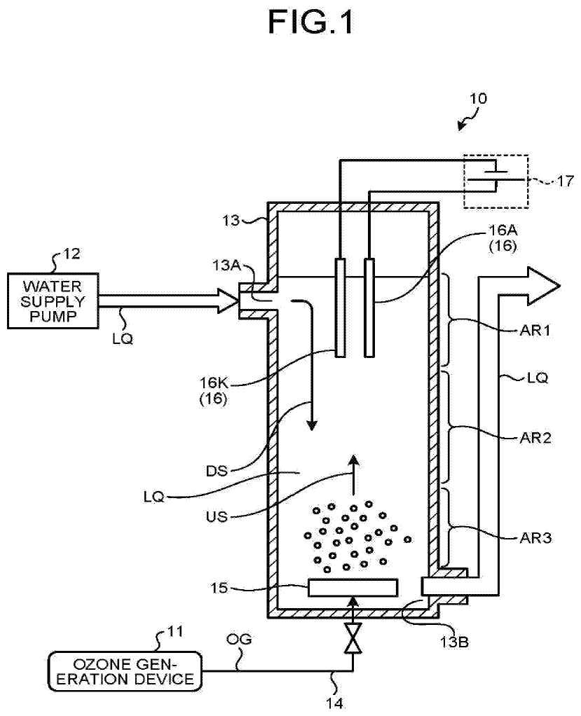

FIG. 1 is a schematic configuration block diagram of a water treatment system in a first embodiment.

A water treatment system 10 includes an ozone generation device 11 that discharges electricity to oxygen or dry air as raw material gas to generate ozone gas, and supplies ozonized gas (═O₃+O₂ or O₃+O₂+N₂) containing ozone gas; a water supply pump 12 for supplying water to be treated LQ being liquid of interest, a reaction vessel 13 that contains the water to be treated LQ, an air diffuser unit 15 disposed at the bottom of the reaction vessel 13 in order to supply ozonized gas OG, supplied through a supply pipe 14, in the form of bubbles to the water to be treated LQ in the reaction vessel 13, an electrolysis electrode pair 16 disposed in the upper part of the reaction vessel 13, for generating hydrogen peroxide (H₂O₂), and a DC power supply 17 that supplies DC power to the electrolysis electrode pair 16.

In the above configuration, the reaction vessel 13 is provided on the top periphery with a water inlet 13A through which the water to be treated is supplied from the water supply pump 12, and provided on the bottom periphery with a water outlet 13D through which the treated water is discharged.

The reason why the electrolysis electrode pair 16, the water inlet 13A, and the water outlet 13B are arranged in the manner as in the embodiment is described.

As illustrated in FIG. 1, in the first embodiment, the reaction vessel 13 includes the water inlet 13A and the electrolysis electrode pair 16 in the upper part, and includes the water outlet 132 in the lower part.

The inventors of the present invention have studied the following four patterns (Pattern A to Pattern D) of the arrangement of the electrolysis electrode pair 16, the water inlet 13A, and the water outlet 13B in the case of disposing the air diffuser unit 15 in the lower part of the reaction vessel 13.

(Pattern A) In the case of placing the electrolysis electrode pair 16 in the upper part of the reaction vessel 13 away from the air diffuser unit 15, placing the water inlet 13A in the upper part of the reaction vessel 13, and placing the water outlet 138 in the lower part of the reaction vessel 13 (first embodiment).

(Pattern B) In the case of placing the electrolysis electrode pair 16 near the air diffuser unit 15 in the reaction vessel 13, placing the water inlet 13A in the lower part of the reaction vessel 13, and placing the water outlet 138 in the upper part of the reaction vessel 13.

(Pattern C) In the case of placing the electrolysis electrode pair 16 in the upper part of the reaction vessel 13 away from the air diffuser unit 15, placing the water inlet 13A in the lower part of the reaction vessel 13, and placing the water outlet 13B in the upper part of the reaction vessel 13.

(Pattern D) In the case of placing the electrolysis electrode pair 16 near the air diffuser unit 15 in the reaction vessel 13, placing the water inlet 13A in the upper part of the reaction vessel 13, and placing the water outlet 13B in the lower part of the reaction vessel 13.

The patterns are discussed below.

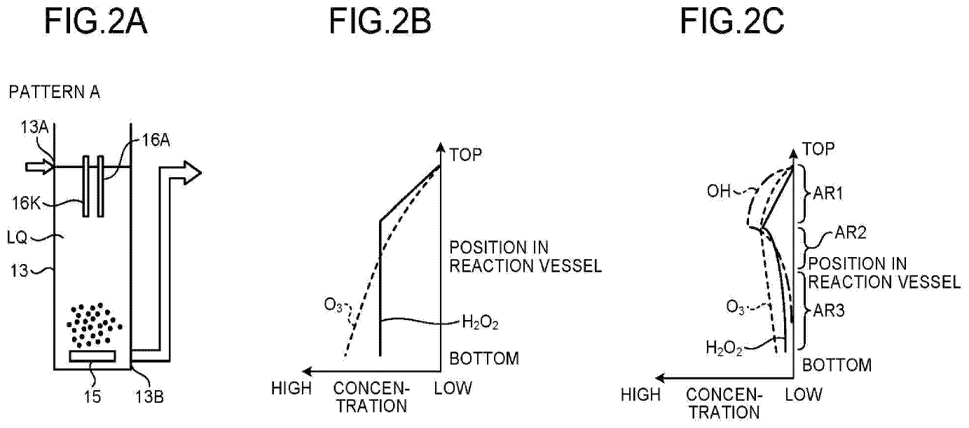

FIG. 2 is an explanatory diagram of distributions of ozone concentration, hydrogen peroxide concentration, and OH radical concentration in Pattern A.

In Pattern A, as illustrated in FIG. 2(a), the electrolysis electrode pair 16 is disposed at the upper part of the reaction vessel 13 away from the air diffuser unit 15, the water inlet 13A is disposed at the upper part of the reaction vessel 13, and the water outlet 13B is disposed at the lower part of the reaction vessel 13.

In Pattern A, upon assumption that ozone and hydrogen peroxide do not react, the concentration of ozone gradually decreases as being away from the air diffuser unit 15 as illustrated in FIG. 2(b).

The concentration of hydrogen peroxide gradually increases from the upper part toward the lower part of the reaction vessel 13 near the electrolysis electrode pair 16, and exhibits a substantially constant value at a given position.

When ozone and hydrogen peroxide react in this state, a concentration distribution will be, as illustrated in FIG. 2(c), such that the concentration of OH radicals reaches maximum near the lower part of the electrolysis electrode pair 16 and thereafter gradually decreases toward the lower part of the reaction vessel.

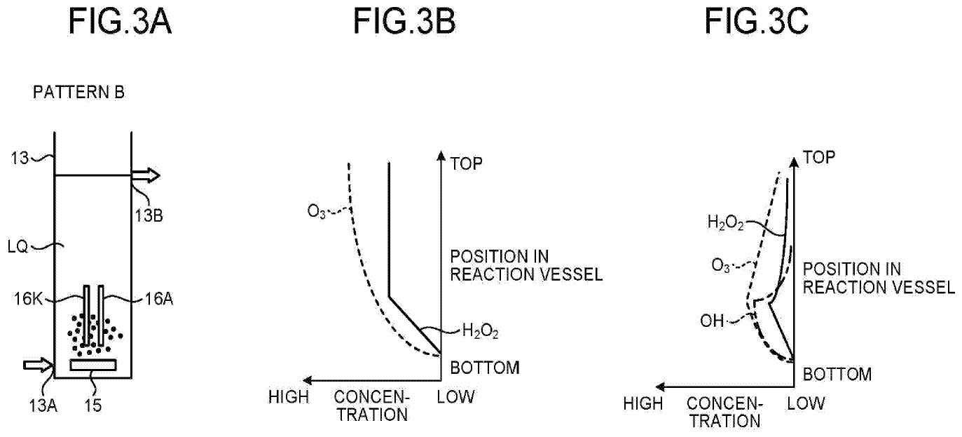

FIG. 3 is an explanatory diagram of distributions of ozone concentration, hydrogen peroxide concentration, and OH radical concentration in Pattern B.

In Pattern B, as illustrated in FIG. 3(a), the electrolysis electrode pair 16 is disposed near the air diffuser unit 15 in the reaction vessel 13, the water inlet 13A is disposed in the lower part of the reaction vessel 13, and the water outlet 13B is disposed in the upper part of the reaction vessel 13.

In Pattern B, upon assumption that ozone and hydrogen peroxide do not react, the concentration of ozone gradually increases as being away from the air diffuser unit 15 as illustrated in FIG. 3(b).

The concentration of hydrogen peroxide gradually increases from the lower part toward the upper part of the reaction vessel 13 near the electrolysis electrode pair 16, and exhibits a substantially constant value at a given position.

When ozone and hydrogen peroxide react in this state, a concentration distribution will be, as illustrated in FIG. 3(c), such that the concentration of OH radicals reaches maximum near the upper part of the electrolysis electrode pair 16 and thereafter gradually decreases toward the upper part of the reaction vessel.

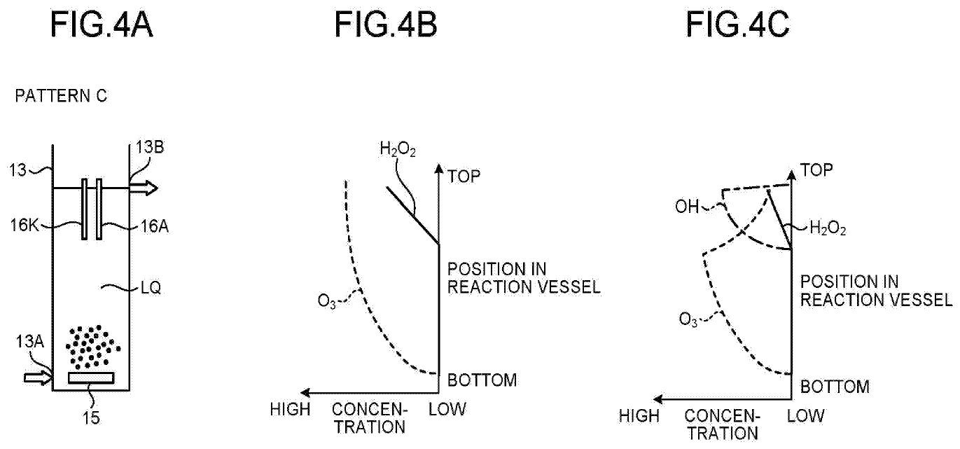

FIG. 4 is an explanatory diagram of distributions of ozone concentration, hydrogen peroxide concentration, and OH radical concentration in Pattern C.

In Pattern C, as illustrated in FIG. 4(a), the electrolysis electrode pair 16 is disposed in the upper part of the reaction vessel 13 away from the air diffuser unit 15, the water inlet 13A is disposed in the lower part of the reaction vessel 13, and the water outlet 13B is disposed in the upper part of the reaction vessel 13.

Upon assumption that ozone and hydrogen peroxide do not react, the concentration of ozone gradually increases as being away from the air diffuser unit 15 as illustrated in FIG. 4(b).

The concentration of hydrogen peroxide gradually increases from the lower part toward the upper part of the reaction vessel 13 near the electrolysis electrode pair 16.

When ozone and hydrogen peroxide react in this state, a concentration distribution will be, as illustrated in FIG. 4(c), such that OH radicals occur only near the electrolysis electrode pair 16, the concentration of OH radicals increases from the lower part toward the upper part of the electrolysis electrode pair 16 and reaches maximum near the upper part of the electrolysis electrode pair 16, and abruptly decreases due to disappearance of ozone and hydrogen peroxide.

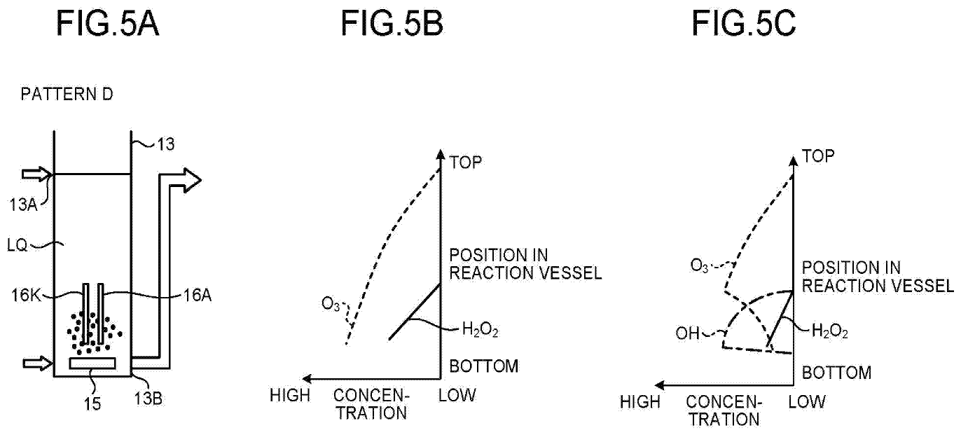

FIG. 5 is an explanatory diagram of distributions of ozone concentration, hydrogen peroxide concentration, and OH radical concentration in Pattern D.

In Pattern D, as illustrated in FIG. 5(a), the electrolysis electrode pair 16 is disposed near the air diffuser unit 15 in the reaction vessel 13, the water inlet 13A is disposed in the upper part of the reaction vessel 13, and the water outlet 13D is disposed in the lower part of the reaction vessel 13.

Upon assumption that ozone and hydrogen peroxide do not react, the concentration of ozone gradually decreases as being away from the air diffuser unit 15 as illustrated in FIG. 5(b).

The concentration of hydrogen peroxide decreases from the lower part toward the upper part of the electrolysis electrode pair 16, and becomes substantially zero near the upper end of the electrolysis electrode pair 16.

When ozone and hydrogen peroxide react in this state, a concentration distribution will be, as illustrated in FIG. 5(c), such that the concentration of OH radicals reaches maximum near the lower part of the electrolysis electrode pair 16 and gradually decreases toward the upper end of the electrolysis electrode pair 16.

In summary, in Pattern C and Pattern D, due to the location of the electrolysis electrode pair 16 in the vicinity of the water outlet 13B, hydrogen peroxide generated by electrolysis immediately flows out from the water outlet 13B after the generation. Thus, OH radicals are produced only in the vicinity of the electrolysis electrode pair 16. The lifetime of OH radicals is short, and hence the OH radicals will immediately disappear after flowing out from the water outlet 13B. Thus, the area where advanced oxidation process (APP) reaction by OH radicals occurs is limited to near the electrolysis electrode pair 16.

Thus, the reaction area by ozone gas alone increases, so that particularly in a clean water treatment system, it is highly possible that bromate ions may be produced by ozone reaction as a by-product.

Furthermore, this may further bring cost increase for recovering or processing remaining ozone gas.

Meanwhile, in Pattern A and Pattern B, as compared with Pattern C and Pattern D, the area where hydrogen peroxide and ozone react increases, which increases the area where OH radicals are generated in longitudinal (vertical) direction of the reaction vessel 13, and increases the AOP reaction area by OH radicals.

Oxygen gas existing as air bubbles, not oxygen dissolved in water, increases in diameter of air bubbles as approaching the water surface because of water pressure. Thus, performing electrolysis in the area closer to the water surface results in increasing the reaction area of oxygen gas, and generating a larger amount of hydrogen peroxide.

Thus, between Pattern A and Pattern B, electrolysis is performed in the area closer to the water surface in Pattern A, which can easily generate hydrogen peroxide, and further increase the AOP reaction area.

For this reason, the first embodiment has adopted the arrangement in Pattern A.

Next, the electrolysis electrode pair 16 is described in detail.

In the above configuration, the electrolysis electrode pair 16 includes a cathode electrode 16K and an anode electrode 16A.

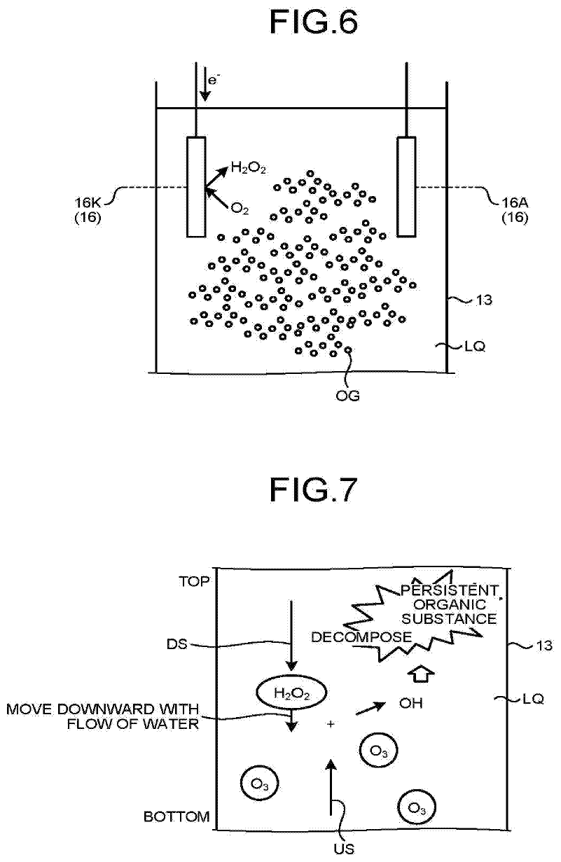

FIG. 6 is a schematic diagram of hydrogen peroxide production with the electrolysis electrode pair 16.

Production of hydrogen peroxide (H₂O₂) is expressed by the following Formula (1). Hydrogen peroxide is produced from oxygen gas contained in ozonized gas OG supplied from the lower part of the reaction vessel 13 through the air diffuser unit 15.

The material of the cathode electrode 16K exerts a particular influence on the production efficiency of hydrogen peroxide.

O₂+2H⁺+2e⁻→H₂O₂ (1)

In other words, the cathode electrode 16K needs to be the one suited for the production of hydrogen peroxide.

For example, the amount of hydrogen peroxide produced by the cathode electrode 16K increases in proportion to current density (mA/cm²) of DC current by an applied DC voltage (current value with respect to apparent area of electrode).

It is desirable that the surface of the cathode electrode 16K be hydrophobic so that the surface can easily absorb oxygen gas serving as raw material of hydrogen peroxide. In order to widen a micro reaction field and enhance reaction efficiency, the surface is desirably porous. Thus, the surface can be, for example, an electrode obtained by coating a carbon electrode being an electrode core with a Teflon (registered trademark)-based suspension (applied with hydrophobic property) and conductive carbon powder (applied with porous property).

The following describes current efficiency.

In the case of the reaction in Formula (1), the theoretical production amount m of hydrogen peroxide is expressed by the following expression in accordance with Faraday's electrolysis law.

M=(I·t·M)/(z·F)

wherein m [g] represents the theoretical production amount of hydrogen peroxide, M (=34) represents the molecular weight of hydrogen peroxide, I[A] represents DC current flowing between the cathode electrode 16K and the anode electrode 16A, t [sec] represents reaction time, z (=2) represents valence, and F [C/mol] represents the Faraday constant (=9.6485×10⁴).

When the actual production amount of hydrogen peroxide is defined as m₁, the current efficiency X [%] is expressed by the following Formula (2).

X=m₁/m×100 (2)

In actual calculation of the current efficiency, in the case of using a carbon electrode as the cathode electrode 16K, the current efficiency was about 20% to 50%, while in the case of using an electrode obtained by coating a carbon electrode with a Teflon-based suspension and conductive carbon powder, the current efficiency was 90% or more.

Thus, the use of the electrode of the first embodiment obtained by coating a carbon electrode with a Teflon-based suspension and conductive carbon powder as the cathode electrode 16K makes it possible to produce hydrogen peroxide with lower power consumption, which leads to cost reduction.

Meanwhile, the anode electrode 16A hardly affects the production of hydrogen peroxide, therefore, the material of the anode electrode 16A is not particularly limited. It is preferable that the material be less dissolved by electrolysis or hardly affect treated water quality when dissolved, and be more conductive. Examples of the material include an insoluble metal electrode. Specific examples include a platinum electrode and a titanium-coated electrode.

The hydrogen peroxide production rate during supply of pure oxygen is described in more detail.

For example, the cathode electrode 16K is a carbon-based electrode obtained by coating of a Teflon-based suspension and conductive carbon powder, and the anode electrode 16A is platinum.

When DC voltage was applied such that a DC current flowing between the cathode electrode 16K and the anode electrode 16A was 40 mA/cm², the production rate of hydrogen peroxide was 25 mg/cm²/h (=current efficiency 92%).

In practice, it is preferable that the current density be 100 mA/cm² or less to attain a necessary production rate.

The following describes the operation in the embodiment.

First, when supplied with oxygen or dry air as raw material gas, the ozone generation device 11 discharges electricity to raw material gas to generate ozone gas O₃.

In this case, oxygen contained in the raw material gas partly remains and is released as oxygen (O₂) together with ozone gas O₃. In the following, ozone gas O₃ and the remaining oxygen gas O₂ are collectively referred to as “ozonized gas OG”.

FIG. 7 is an explanatory diagram of the operation of generating OH radicals.

Ozonized gas OG (=O₃+O₂) generated by the ozone generation device 11 is supplied to the air diffuser unit 15 through the supply pipe 14, and released into the water to be treated LQ in the form of bubbles to form an upward flow US of the ozonized gas OG (=O₃+O₂).

In this case, ozone O₃ constituting the ozonized gas OG dissolves in the water to be treated LQ. Meanwhile, oxygen O₂ constituting the ozonized gas OG is not greatly dissolved in the water to be treated LQ and continuously rises as air bubbles, and reaches the location of the electrolysis electrode pair 16 to serve as raw material of hydrogen peroxide.

Concurrently, when a given DC voltage is applied between the cathode electrode 16K and the anode electrode 16A by the DC power supply 17, hydrogen peroxide is produced at a given production rate due to oxygen gas O₂ in the water to be treated LQ by reaction expressed by Formula (1).

The amount of produced hydrogen peroxide is proportional to the applied voltage for electrolysis, that is, the magnitude of DC current flowing between the cathode electrode 16K and the anode electrode 16A. In view of this, the magnitude of DC current is adjusted depending on the concentration of aquatic compound components to be decomposed and components that consume OH radicals.

The water to be treated LQ is supplied from the water supply pump 12 through the water inlet 13A in this state, and forms a downward flow DS in which the produced hydrogen peroxide is dissolved.

Thus, the upward flow US of the ozonized gas OG and the downward flow DS including the dissolved hydrogen peroxide form countercurrents, which cause the hydrogen peroxide in the water to be treated to react with the dissolved ozone to produce highly oxidative OH radicals.

As a result, a high hydrogen-peroxide concentration and low ozone concentration area AR1, a pro-oxidant area AR2, and a low hydrogen-peroxide concentration and high ozone concentration area AR3 are formed in the reaction vessel 13 in this order from the upper part toward the lower part.

In the pro-oxidant area AR, OH radicals react with aquatic compound components (components to be treated) included in the water to be treated, and the decomposition of persistent aquatic compound components advances.

While the downward flow DS of the water to be treated LQ travels downward in the reaction vessel 13, hydrogen peroxide dissolved in the water to be treated and dissolved ozone are consumed.

However, due to the continuous supply of ozonized gas OG from the lower part of the reaction vessel 13, ozone O₃ included in the upward flow US is newly dissolved. Thus, the dissolved ozone concentration necessary for water treatment can be maintained to continuously treat the water.

In the high hydrogen-peroxide concentration and low ozone concentration area AR1, the dissolved ozone cannot exist at high concentration because of a high concentration of hydrogen peroxide. By applying the water treatment system 10 in the first embodiment to a clean water treatment system, the generation of bromide (bromic acid, bromoform) can be prevented.

As described above, according to the first embodiment, the air diffuser unit 15 injects ozonized gas OG into the lower part of the reaction vessel 13, to dissolve ozone O₃ in the water to be treated LQ for ozone treatment.

Concurrently with the ozone treatment, hydrogen peroxide is produced by electrolysis using oxygen O₂ in the ozonized gas OG. Highly oxidative OH radicals are thus produced from the dissolved ozone and the produced hydrogen peroxide.

That is, it is made possible to efficiently decompose persistent aquatic compound components in the water to be treated LQ.

Consequently, according to the first embodiment, without hydrogen peroxide as reagent, surplus ozone becomes short-lived OH radicals by the produced hydrogen peroxide and is consumed.

As a result, it is possible to prevent the generation of bromid such as bromic acid and bromoform, particularly in clean water treatment without treating or recovering the remaining ozone.

Using a carbon electrode subjected to hydrophobic and porous treatment as the cathode electrode 16K makes it possible to enhance the efficiency of hydrogen peroxide production and reduce the power necessary for the hydrogen peroxide production.

In addition, the downward flow DS can convey the hydrogen peroxide produced in the upper part to the lower part in the reaction vessel 13. Thus, OH radicals can be produced in a wider area of the reaction vessel 13 to oxidatively decompose persistent substances in the water, thereby improving treatment capacity. This results in improving the use efficiency of dissolved ozone and reducing unreacted ozone.

### [1.1] First Modification of First Embodiment

The above has described the example of a single reaction vessel. In a first modification, a plurality of reaction vessels is effectively provided.

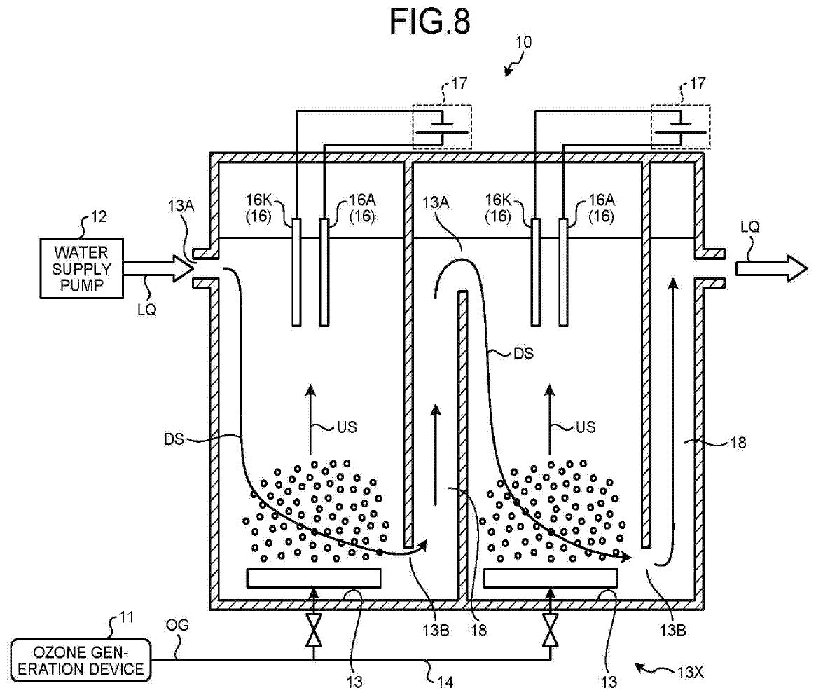

FIG. 8 is an explanatory diagram of the first modification of the first embodiment.

In FIG. 8, the same elements as in FIG. 1 are denoted by the same reference symbols.

As illustrated in FIG. 8, reaction vessels 13 are connected through communicating channels 18a to form a reaction vessel group 13X.

Water to be treated LQ is subjected to the advanced oxidation process and ozone treatment in an upstream reaction vessel 13 in the reaction vessel group 13X, is introduced from the water inlet 13A of a downstream reaction vessel 13 through the communicating channel 18 and subjected to the advanced oxidation process and ozone treatment again, and is supplied to downstream treatment through the water outlet 13B and the communicating channel 18.

Thus, a substance not decomposed through the first treatment can be decomposed through the second treatment, improving effective treatment efficiency.

In this case, in each of the reaction vessels 13, the generation amount of hydrogen peroxide and the supply amount of ozonized gas OG can be appropriately set as necessary.

The above has described the example of two reaction vessels connected in cascade. However, three or more reaction vessels may be cascaded.

In these cases, the reaction vessels 13 closer to raw water may be connected in parallel to decrease the number of parallel connections sequentially. For example, firstly, two reaction vessels 13 are connected in parallel, and secondly, only one reaction vessel 13 is connected.

As described above, according to the first modification, it is possible to improve effective treatment efficiency through two or more levels of water treatment.

### [1.2] Second Modification of First Embodiment

The above has described one electrolysis electrode pair 16 provided for each reaction vessel 13. However, a plurality of electrolysis electrode pairs 16 may be placed depending on the size of the reaction vessels 13. This enables sufficient supply of necessary hydrogen peroxide.

### [2] Second Embodiment

The first embodiment described above has used the air diffuser unit 15 to dissolve the ozone gas O₃ into the water to be treated LQ. A second embodiment uses an injector instead, to dissolve ozone gas in the water to be treated LQ by gas suction and injection method using pressurized water.

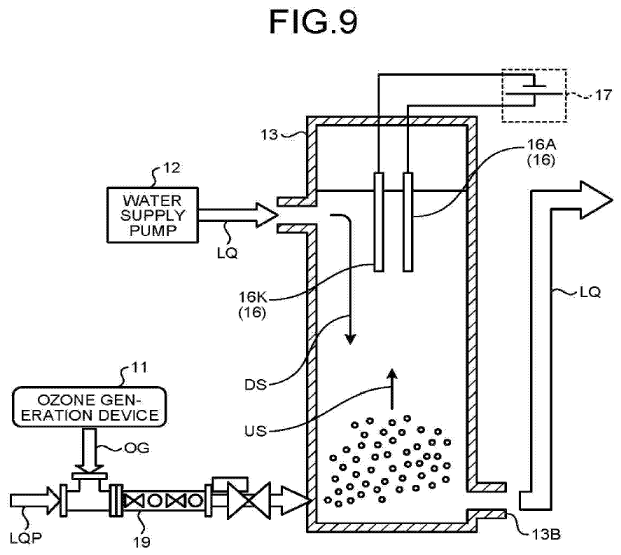

FIG. 9 is a schematic configuration block diagram of a water treatment apparatus in the second embodiment.

Gas suction and injection method using pressurized water refers to a method of conveying pressurized water to a nozzle, and suctioning and injecting ozonized gas OG into water using a pressure difference in the nozzle.

To implement this method, in the second embodiment, pressurized raw water LQP as branched water to be treated LQ, treated water LQ or clear water such as tap water is supplied to a device called an injector 19.

Concurrently, the injector 19 is supplied with ozonized gas OG from the ozone generation device 11.

The injector 19 mixes the ozonized gas OG into the pressurized raw water LQP, and pressurizes and supplies the mixture into the reaction vessel 13.

The subsequent operation is substantially the same as the operation in the first embodiment in which the ozonized gas OG is supplied by the air diffuser unit.

In addition to the effects in the first embodiment, the second embodiment can more reliably generate dissolved ozone to improve treatment capacity.

### [3] Third Embodiment

The first embodiment and the second embodiment described above have not subjected the upward flow US of the ozonized gas OG to any control. A third embodiment additionally includes a current plate below the electrolysis electrode pair 16 in order to guide oxygen O₂ contained in the ozonized gas OG into the region between the cathode electrode 16K and the anode electrode 16A that generate hydrogen peroxide.

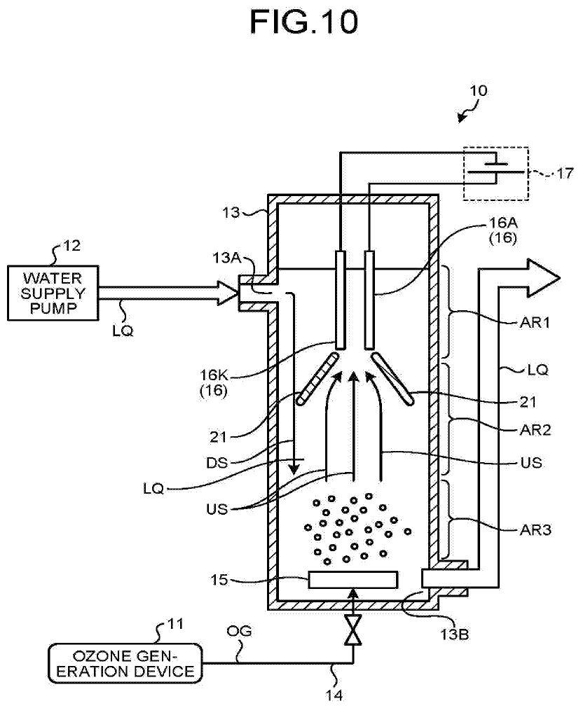

FIG. 10 is an explanatory diagram of the third embodiment.

In FIG. 1, the same elements as in FIG. 1 are denoted by the same reference symbols.

A current plate 21 has a shape with a wider opening area at bottom end and a narrower opening area at top end. The current plate 21 has a shape sufficient to guide mainly the upward flow US of the ozonized gas OG into the region between the cathode electrode 16K and the anode electrode 16A.

Consequently, according to the third embodiment, it is possible to efficiently guide the oxygen O₂ included in the ozonized gas OG between the cathode electrode 16K and the anode electrode 16A for generating hydrogen peroxide H₂O₂, which can improve effective hydrogen peroxide production efficiency and OH radical production efficiency to enhance the efficiency of advanced oxidation process.

### [4] Effect of Embodiment

According to the respective embodiments, it is possible to construct a water treatment apparatus as well as a water treatment system with a simple configuration at lower cost without using hydrogen peroxide as reagent.

The cathode electrode constituting the electrolysis electrode pair includes an electrode core made of carbon, a porous carbon layer laminated on the electrode core, and a hydrophobic layer formed on the surface of the porous carbon layer by coating. This structure enables increase in efficiency of hydrogen peroxide production and decrease in required power.

In addition, the reaction vessel 13 is provided in the upper part with the water inlet 13A (inflow) into which the water to be treated LQ flows, so that flow of water is mainly directed downward. The water mainly flowing downward contacts the rising ozonized gas OG injected to the lower part of the reaction vessel 13, forming countercurrents, which can thereby improve the ozone dissolution efficiency. Furthermore, hydrogen peroxide produced by electrolysis near the water inlet 13A (inflow) contacts dissolved ozone together with the downward flow of water to produce OH radicals, causing persistent substances in the water to react with the OH radicals for oxidative decomposition in a wider area of the reaction vessel.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A water treatment apparatus, comprising:
a reaction vessel that contains water to be treated, and that includes an upper part from which the water to be treated is introduced and a lower part from which the water to be treated is discharged, to form a downward flow;
an ozone supply unit that supplies ozonized gas into the reaction vessel from the lower part to form an upward flow of the ozonized gas containing ozone gas and oxygen; and
an electrolysis electrode pair placed on the upper part of the reaction vessel, the pair that produces hydrogen peroxide from the water to be treated and the oxygen gas contained in the ozonized gas by electrolysis.

2. The water treatment apparatus according to claim 1, wherein
the electrolysis electrode pair includes a cathode electrode including:
an electrode core made of carbon;
a porous carbon layer laminated on the electrode core; and
a hydrophobic layer formed on a surface of the porous carbon layer by coating.

3. The water treatment apparatus according to claim 2, wherein
the porous carbon layer is laminated by coating with conductive carbon powder, and
the hydrophobic layer is formed by coating with a Teflon-based suspension.

4. The water treatment apparatus according to claim 1, wherein
the reaction vessel comprises a plurality of reaction vessels each including the ozone supply unit and the electrolysis electrode pair, and
the reaction vessels are cascaded such that the water to be treated discharged from an upstream reaction vessel is introduced into a downstream reaction vessel.

5. The water treatment apparatus according to claim 1, wherein
the ozone supply unit includes an air diffuser unit or an injector.

6. A water treatment system, comprising:
the water treatment apparatus according to claim 1;
an ozone generation device that discharges electricity to raw material gas containing oxygen, and supplies the raw material gas as the ozonized gas to an air diffuser unit located in the reaction vessel; and
a direct-current power supply that supplies direct-current power to the electrolysis electrode pair.

7. A water treatment method to be performed by a water treatment apparatus, the apparatus comprising a reaction vessel which comprises an upper part provided with a water inlet and an electrolysis electrode pair, and a lower part provided with a water outlet and an air diffuser unit, the method comprising:
introducing water to be treated through the water inlet to form a downward flow;
supplying ozonized gas containing ozone gas and oxygen gas through the air diffuser unit to form an upward flow of the ozonized gas;
subjecting the water to be treated to ozone treatment by dissolved ozone;
supplying direct-current power to the electrolysis electrode pair to produce hydrogen peroxide from the oxygen gas and the water to be treated, and supplying the hydrogen peroxide to the downward flow; and
mixing the downward flow and the upward flow into countercurrents, to produce OH radicals through reaction between the dissolved ozone and the hydrogen peroxide for advanced oxidation process.
